(19) United States
(12) Patent Application Publication
(10) Pub. No.: US 2026/0084634 A1
(43) Pub. Date: Mar. 26, 2026

(54) VIBRATION DAMPENING FOR A WIRING HARNESS

(71) Applicant: Allison Transmission, Inc., Indianapolis, IN (US)

(72) Inventors: Megan Shamseddeen, Greenwood, IN (US); Ronald Dailey, Danville, IN (US); Rebecca Schenk, Indianapolis, IN (US)

(21) Appl. No.: 18/892,899

(22) Filed: Sep. 23, 2024

(51) Int. Cl. B60R 16/02; H02G 3/04

(52) U.S. Cl. CPC B60R 16/0215; H02G 3/0437

(57) ABSTRACT

A damper for a wire harness having a plurality of wires is provided. The plurality of wires may extend beyond a first end of a sheath and be coupled to a header. The damper may comprise a body having a first end and a second end and an interior channel extending from the first end to the second end. The first end being sized and shaped to receive a portion of the header and the second end being sized and shaped to receive a portion of the sheath. The interior channel may be tapered between the first end and the second end. The damper may further comprise a plurality of spaced apart vibration fins extending from the body between the first end and the second end. The header may be part of a resolver assembly which may further include a stator, a housing having a first portion sized and shaped to receive the stator and a second portion having a channel connecting the first portion with a first end of the housing. The damper may be positioned in the second portion of the housing.

### FIELD OF THE DISCLOSURE

The present disclosure relates to vibration dampening components for a wiring harness. More particularly, the present disclosure relates to vibration dampening components for securing a wiring harness and stator of a resolver mounted on an axle of a vehicle.

### BACKGROUND OF THE DISCLOSURE

Referring to FIG. 1, a resolver 10 is an electromagnetic transducer which provides a speed and angular position of a shaft 12 passing through an opening 14 in resolver 10. As is known, resolver 10 includes a stator 16 having a plurality of windings (not shown) which sense the position of shaft 12. Each of the windings are connected to respective wires 22 at a header 24. Wires 22 are held together by a sheath to form a wire harness 30 which is connected to a controller 32. Controller 32 based on the signals measured on wires 22 is able to determine the speed and position of shaft 12.

As shown in FIG. 1A, wire harness 30 in applications may be bent to be routed to controller 32 and wires 22 are unsupported at connections 25 to header 24 of resolver 10. In the shown example, the connection between wires 22 and header 24 may become fatigued resulting in one or more wires 22 being broken away from header 24 thereby preventing controller 32 from being able to accurately determine the speed and position of shaft 12.

### SUMMARY OF THE DISCLOSURE

The present disclosure provides systems and methods for reducing vibration. Exemplary dampers and systems are disclosed. Example embodiments include but are not limited to the following embodiments.

In an exemplary embodiment of the present disclosure, a resolver assembly is provided. The resolver assembly comprising: a stator; a header operatively coupled to the stator; a plurality of wires coupled to the header; a sheath surrounding a first portion of the plurality of wires; a housing having a first portion sized and shaped to receive the stator and a second portion having a channel connecting the first portion with a first end of the housing; and a damper positioned in the second portion of the housing. The damper having a channel receiving the wires and a first portion of the sheath.

In an example thereof, the channel of the damper has an open top. In another example thereof, the channel of the damper defines an interior of a body of the damper. In a variation thereof, the body has a first end and a second end, the first end sized and shaped to receive a portion of the header and the second end sized and shaped to receive the portion of the sheath. In a further variation thereof, the interior channel is tapered between the first end and the second end. In another variation thereof, the damper further comprises a plurality of spaced apart vibration fins extending from the body between the first end and the second end and contacting a boundary of the channel in the housing connecting the first portion with the first end of the housing. In a refinement thereof, the interior channel of the damper transitions from a substantially rectilinear profile at the first end to a cylindrical profile at the second end. In another refinement thereof, a first portion of the plurality of spaced apart vibration fins of the damper extend from the first end of the body of the damper to the second end of the body of the damper. In a further refinement thereof, a second portion of the plurality of spaced apart vibration fins of the damper extend from the second end of the body of the damper to an intermediate position on the body of the damper between the first end of the body of the damper and the second end of the body of the damper. In yet a further refinement thereof, the second portion of the plurality of spaced apart vibration fins blend into an outer envelope of the body of the damper at the intermediate position. In still another refinement thereof, the damper further comprises a tab intersecting the first end of the body of the damper and extending above the outer envelope of the body of the damper. In yet still a further refinement thereof, the damper further comprises a plurality of alignment pins positioned within the internal channel proximate the first end of the body of the damper.

In another exemplary embodiment of the present disclosure, a damper for a wire harness having a plurality of wires is provided. The plurality of wires extending beyond a first end of a sheath and coupled to a header. The damper comprising a body having a first end and a second end and an interior channel extending from the first end to the second end. The first end sized and shaped to receive a portion of the header and the second end sized and shaped to receive a portion of the sheath. The interior channel being tapered between the first end and the second end. The damper further comprising a plurality of spaced apart vibration fins extending from the body between the first end and the second end.

In an example thereof, the interior channel transitions from a substantially rectilinear profile at the first end to a cylindrical profile at the second end. In another example thereof, a first portion of the plurality of spaced apart vibration fins extends from the first end of the body to the second end of the body. In a variation thereof, a second portion of the plurality of spaced apart vibration fins extend from the second end of the body to an intermediate position on the body between the first end of the body and the second end of the body. In a further variation thereof, the second portion of the plurality of spaced apart vibration fins blend into an outer envelope of the body at the intermediate position. In a refinement thereof, the damper further comprises a tab intersecting the first end of the body and extending above the outer envelope of the body.

In a further example thereof, the damper further comprises a tab intersecting the first end of the body and extending above the outer envelope of the body. In still a further example thereof, the damper further comprises a plurality of alignment pins positioned within the internal channel proximate the first end.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The above-mentioned and other features and advantages of this disclosure, and the manner of attaining them, will become more apparent and will be better understood by reference to the following description of exemplary embodiments taken in conjunction with the accompanying drawings, wherein:

FIG. 1 illustrates a representative view of a conventional resolver assembly;

FIG. 1A illustrates an exemplary bend in the wire harness of the conventional resolver assembly of FIG. 1;

FIG. 2 illustrates a representative view of a resolver assembly of the present disclosure;

FIG. 3 illustrates top perspective view of an exemplary resolver assembly of the present disclosure;

FIG. 4 illustrates a top view of the resolver assembly of FIG. 3 with a damper assembled in a housing;

FIG. 4A illustrates a partial top perspective view of the resolver assembly of FIG. 4;

FIG. 5 illustrates an end view of the resolver assembly of FIG. 4;

FIG. 6 illustrates a top view of an exemplary damper of the resolver assembly of FIG. 3;

FIG. 7 illustrates an end view of the damper of FIG. 6;

FIG. 8 illustrates another end view of the damper of FIG. 6;

FIG. 9 is a sectional view of the damper of FIG. 6 along lines 9-9 in FIG. 6;

FIG. 10 is a perspective view of another exemplary damper;

FIG. 11 is a perspective view of yet another exemplary damper;

FIG. 12 is a perspective view of a further exemplary damper;

FIG. 13 is a perspective end view of still another exemplary damper; and

FIG. 14 is a top perspective view of the damper of FIG. 13.

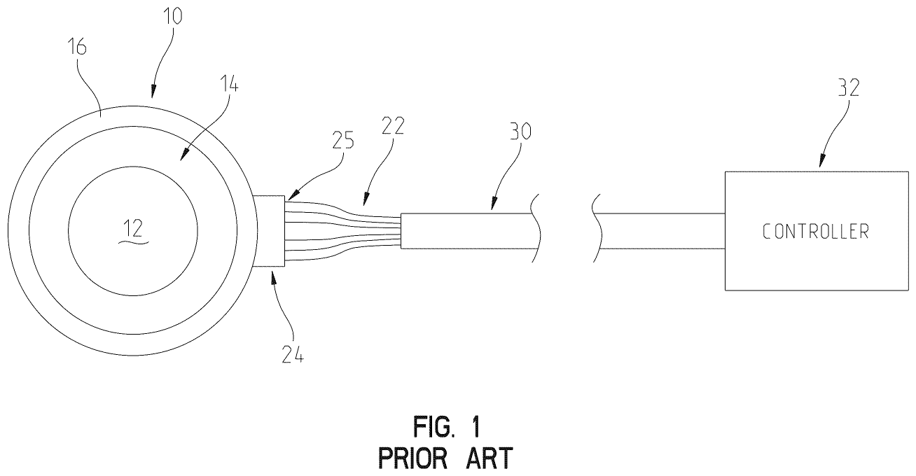

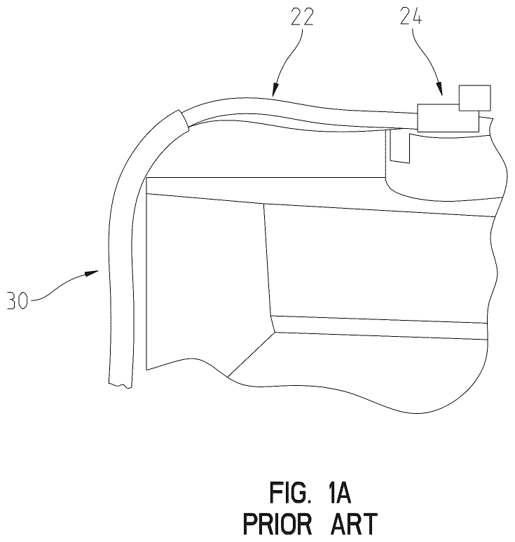

The exemplifications set out herein illustrate exemplary embodiments of the invention and such exemplifications are not to be construed as limiting the scope of the invention in any manner.

### DETAILED DESCRIPTION

For the purposes of promoting an understanding of the principles of the present disclosure, reference is now made to the embodiment illustrated in the drawings, which is described below. The embodiment disclosed below is not intended to be exhaustive or limit the present disclosure to the precise form disclosed in the following detailed description. Rather, the embodiment is chosen and described so that others skilled in the art may utilize its teachings. Therefore, no limitation of the scope of the present disclosure is thereby intended. Corresponding reference characters indicate corresponding parts throughout the several views.

The terms “couples”, “coupled”, “coupler” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

In some instances throughout this disclosure and in the claims, numeric terminology, such as first, second, third, and fourth, is used in reference to various components. Such use is not intended to denote an ordering of the components. Rather, numeric terminology is used to assist the reader in identifying the component being referenced and should not be narrowly interpreted as providing a specific order of components.

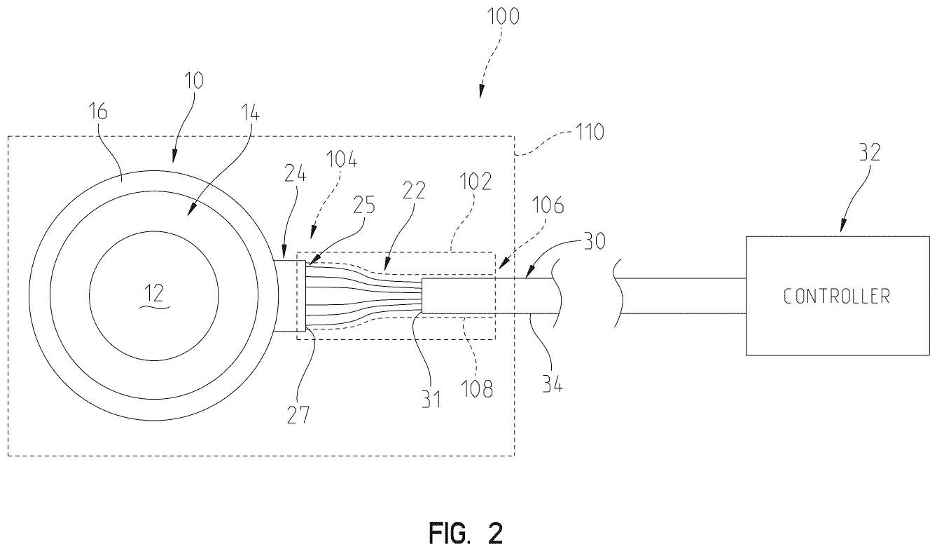

Referring to FIG. 2, an exemplary resolver assembly 100 is shown. Resolver assembly 100 includes a damper 102 having a first end 104 and a second end 106. A channel 108 connects first end 104 and second end 106. First end 104 is sized and shaped to receive a leading end 27 of header 24. Second end 106 is sized and shaped to receive wire harness 30. Channel 108 receives wires 22 and a leading end 31 of wire harness 30. As shown, damper 102 connects header 24 and wire harness 30 independent of wires 22 so that any vibration or movement of an unsupported portion 34 of wire harness 30 does not stress the connections 25 of wires 22 with header 24.

Further, in embodiments, resolver assembly 100 further comprises a housing 110. Housing 110 supports damper 102. Housing 110 further supports resolver 10 and generally holds a position of damper 102 relative to resolver 10.

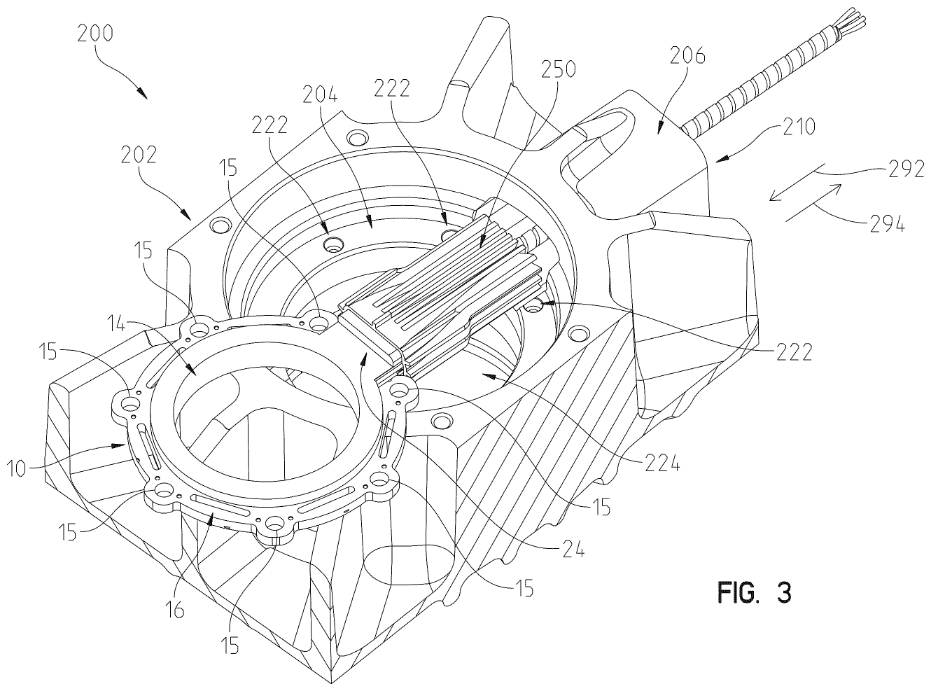

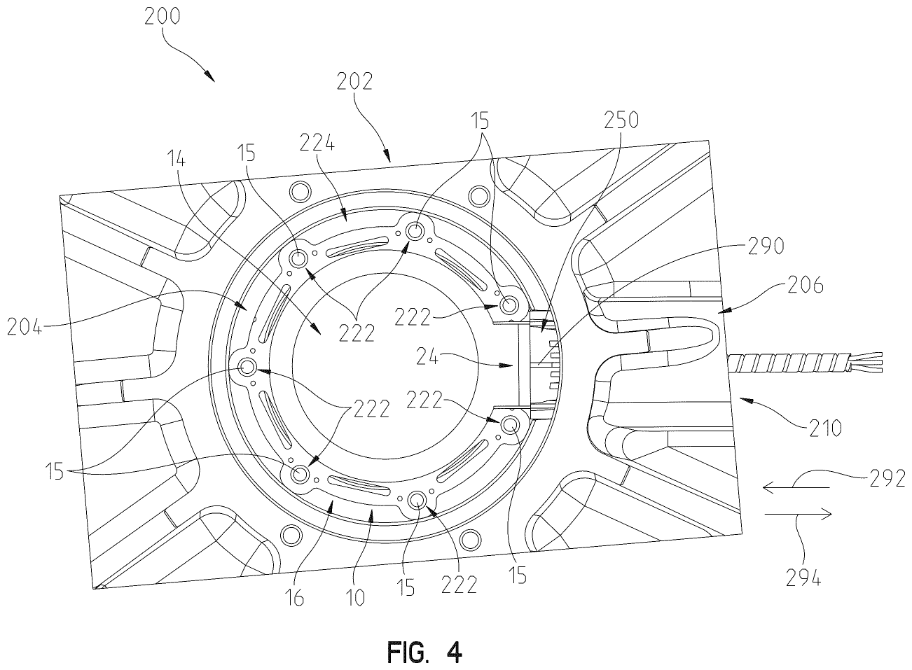

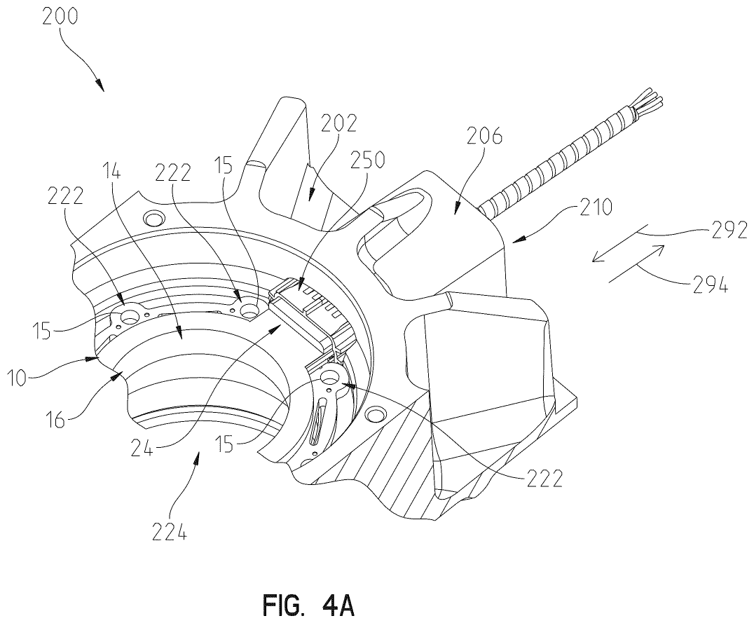

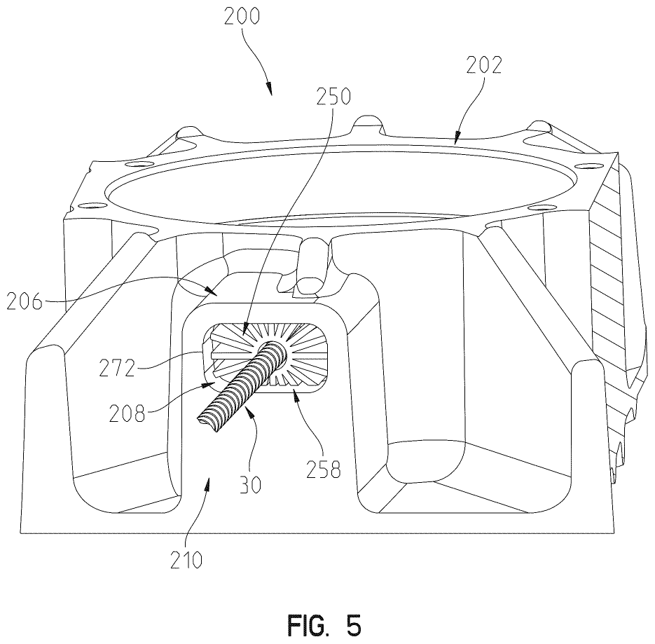

Referring to FIG. 3, an exemplary resolver assembly 200 is shown. Resolver assembly 200 includes a housing 202 having a first portion 204 sized and shaped to receive stator 16 of resolver 10 and a second portion 206 having a channel 208 (see FIG. 5) which connects first portion 204 with a first end 210. First portion 204 includes a recess 220 which receives stator 16 and mounting holes 222 which align with mounting holes 15 in stator 16 to receive fasteners (not shown) to couple stator 16 to housing 202. First portion 204 further includes a central opening 224 which aligns with opening 14 of stator 16 so a shaft 12 may pass therethrough.

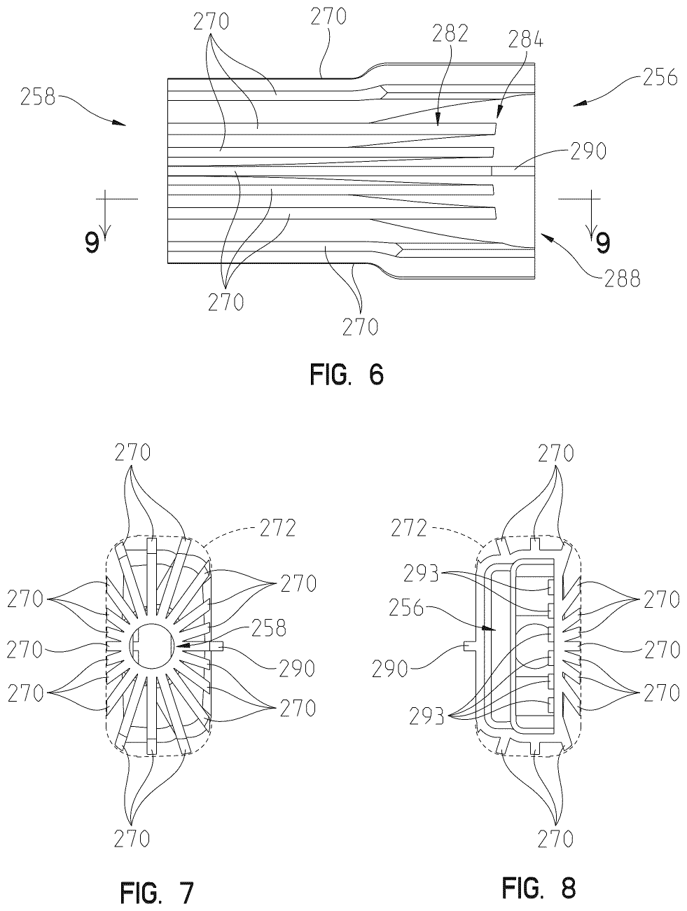

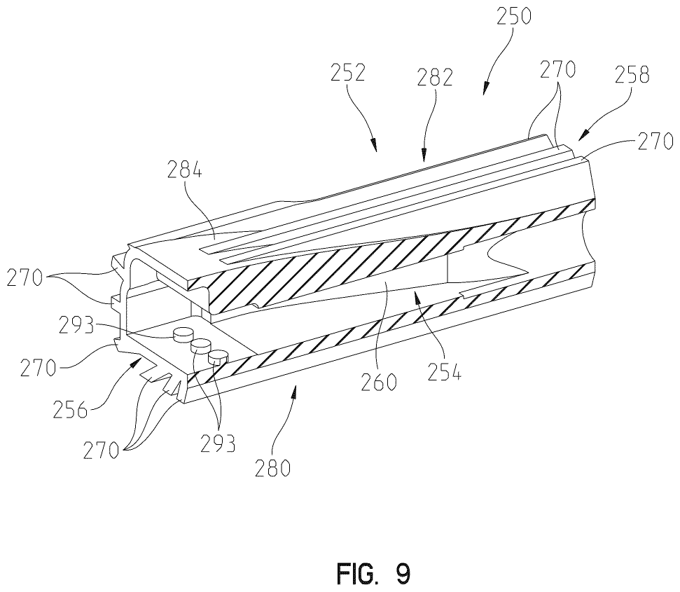

Resolver assembly 200 further comprises a damper 250. Damper 250 is positioned in second portion 206 of housing 202. Referring to FIGS. 6-9, exemplary features of damper 250 are shown. Referring to FIG. 9, damper 250 includes a body 252 having a channel 254 which receives wires 22 and a first portion of wire harness 30. Channel 254 defines an interior space of body 252.

Body 252 further includes a first end 256 and a second end 258. First end 256 is sized and shaped to receive a portion of header 24 (see FIG. 3) and second end 258 is sized and shaped to receive a portion of wire harness 30 (see FIG. 5). Each of the vertical sides of channel 254 are tapered between first end 256 and second end 258. Channel 254 of damper 250 transitions from a substantially rectilinear profile at first end 256 which corresponds to the shape and size of leading end 27 of header 24 to a cylindrical profile at second end 258 which corresponds to the shape and size of wire harness 30. As such, in embodiments, damper 250 is firmly coupled to header 24 at first end 256 and to wire harness 30 at second end 258 while wires 22 are received in channel 254. This arrangement causes damper 250 to resist any movement between wire harness 30 and header 24 that would cause wires 22 to move at connections 25 with header 24 thereby reducing a chance that wires 22 break away from header 24.

Damper 250 further comprises a plurality of spaced apart vibration fins 270 extending from body 252 between first end 256 and second end 258. As shown in FIG. 7, proximate to second end 258 of damper 250 vibration fins 270 contact a boundary 272 of channel 208 in housing 202 which connects first portion 204 with first end 210. Similarly, as shown in FIG. 8, proximate to first end 256 of damper 250 vibration fins 270 contact boundary 272 of channel 208 in housing 202 which connects first portion 204 with first end 210. Referring to FIG. 9, a first portion 280 of vibration fins 270 of damper 250 extend from first end 256 of body 252 to second end 258 of body 252. Further, a second portion 282 of vibration fins 270 of damper 250 extend from second end 258 of body 252 of damper 250 to an intermediate position 284 on body 252 (see also FIG. 6) of damper 250 between first end 256 of damper 250 and second end 258 of damper 250. As shown in FIG. 6, second portion 282 of vibration fins 270 blend into an outer envelope 288 of body 252 of damper 250 at intermediate position 284. An advantage, among others, of vibration fins 270 is that vibration of one or both of header 24 and wire harness 30 may be absorbed by the flexing of vibration fins 270 against boundary 272 of channel 208 which reduces the vibration experienced by wires 22 positioned between first end 256 and second end 258 of damper 250.

Referring to FIG. 6, damper 250 may further include a tab 290. The portion of damper 250 with tab 290 is not received in channel 208 of second portion 206 of housing 202. Rather, tab 290 is accessible by an operator to grasp and aid the operator in moving damper 250 in direction 292 (see FIG. 3) to remove damper 250 from channel 208 and in direction 294 (see FIG. 3) to assembly damper 250 into channel 208. Tab 290 extends above boundary 272 of channel 208 in housing 202.

Referring to FIG. 9, damper 250 further comprises a plurality of alignment pins 293 positioned within channel 254 of body 252 proximate 256 of damper 250. Plurality of alignment pins 293 retain the position of damper 250 on header 24 and assist in alignment of damper 250 relative to header 24. In embodiments, header 24 includes a ridge (not shown) on a lower side and alignment pins 293 flex to pass over the ridge during assembly and return to their upright position once the ridge is cleared to press against a side of the ridge to resist movement of damper 250 in direction 294 which would disengage damper 250 from header 24.

In the illustrated embodiment, damper 250 is an integrally molded component. Damper 250 is made of a flexible material. In some embodiments, damper 250 may be made of nylon 11 with a hardness of 70 durometer. In embodiments, the material of damper 250 has a hardness of between about 70 to about 90 durometer. In some embodiments, damper 250 is made of individual components that are assembled to form damper 250. An exemplary material is Flexible 80A Resin which has a flexibility similar to rubber or thermoplastic polyurethane and an 80A Shore durometer.

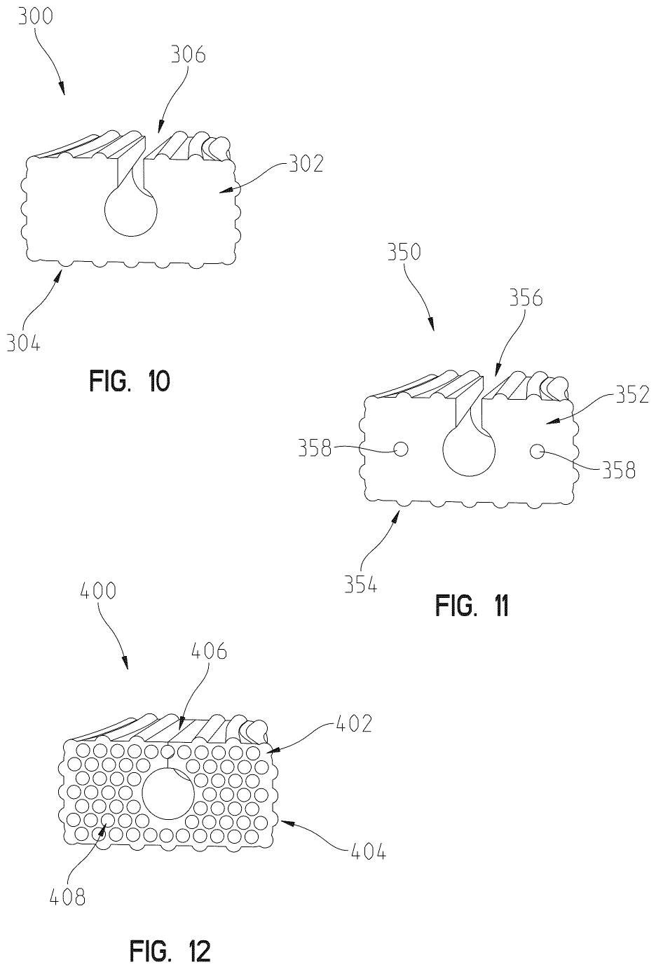

Referring to FIG. 10, another exemplary damper 300 is shown. Damper 300 is sized and shaped to be received within channel 208 of second portion 206 of housing 202. Damper 300 includes a flexible body 302 having a plurality of fins 304 extending therefrom to contact boundary 272 of channel 208. Damper 300 further includes an open top channel 306 which expands to receive wire harness 30 is sized and shaped to hold wire harness 30.

Referring to FIG. 11, another exemplary damper 350 is shown. Damper 350 is sized and shaped to be received within channel 208 of second portion 206 of housing 202. Damper 350 includes a flexible body 352 having a plurality of fins 354 extending therefrom to contact boundary 272 of channel 208. Damper 350 further includes an open top channel 356 which expands to receive wire harness 30 is sized and shaped to hold wire harness 30. Damper 350 further includes a plurality of longitudinal voids 358 which assist in increasing the flexibility of flexible body 352 of damper 350.

Referring to FIG. 12, another exemplary damper 400 is shown. Damper 400 is sized and shaped to be received within channel 208 of second portion 206 of housing 202. Damper 400 includes a flexible body 402 having a plurality of fins 404 extending therefrom to contact boundary 272 of channel 208. Damper 400 further includes an open top channel 406 which expands to receive wire harness 30 is sized and shaped to hold wire harness 30. Damper 400 further includes a plurality of longitudinal voids 408 which assist in increasing the flexibility of flexible body 402 of damper 400.

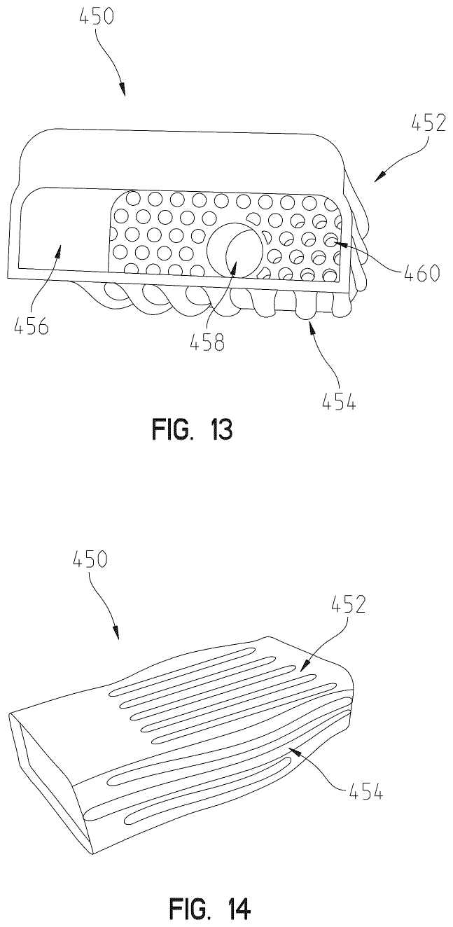

Referring to FIGS. 13 and 14, another exemplary damper 450 is shown. Damper 450 is sized and shaped to be received within channel 208 of second portion 206 of housing 202. Damper 450 includes a flexible body 452 having a plurality of fins 454 extending therefrom to contact boundary 272 of channel 208. Damper 450 further includes an enlarged first end 456 sized and shaped to receive header 24 and a central channel 458 sized and shaped to receive wire harness 30. Damper 450 further includes a plurality of longitudinal voids 460 which assist in increasing the flexibility of flexible body 452 of damper 450.

In the above-described embodiments, dampers are used to support the wiring harness of a resolver. However, it is not uncommon to have wiring harnesses in other applications which are prone to wire fatigue, and the vibration dampers of the present disclosure may be used in such other applications where there is a need to support a wiring harness within an enclosure that experiences vibrations.

While embodiments have been described as having exemplary designs, the present disclosure may be further modified within the spirit and scope of this disclosure. This application is therefore intended to cover any variations, uses, or adaptations of the disclosure using its general principles. Further, this application is intended to cover at least such departures from the present disclosure as come within known or customary practice in the art to which this disclosure pertains and which fall within the limits of the appended claims.

1. A resolver assembly comprising:
a stator;
a header operatively coupled to the stator;
a plurality of wires coupled to the header;
a sheath surrounding a first portion of the plurality of wires;
a housing having a first portion sized and shaped to receive the stator and a second portion having a channel connecting the first portion with a first end of the housing; and
a damper positioned in the second portion of the housing, the damper having a channel receiving the wires and a first portion of the sheath.

2. The resolver assembly of claim 1, wherein the channel of the damper has an open top.

3. The resolver assembly of claim 1, wherein the channel of the damper defines an interior of a body of the damper.

4. The resolver assembly of claim 3, wherein the body has a first end and a second end, the first end sized and shaped to receive a portion of the header and the second end sized and shaped to receive the portion of the sheath.

5. The resolver assembly of claim 4, wherein the interior channel is tapered between the first end and the second end.

6. The resolver assembly of claim 5, wherein the damper further comprises a plurality of spaced apart vibration fins extending from the body between the first end and the second end and contacting a boundary of the channel in the housing connecting the first portion with the first end of the housing.

7. The resolver assembly of claim 6, wherein the interior channel of the damper transitions from a substantially rectilinear profile at the first end to a cylindrical profile at the second end.

8. The resolver assembly of claim 6, wherein a first portion of the plurality of spaced apart vibration fins of the damper extend from the first end of the body of the damper to the second end of the body of the damper.

9. The resolver assembly of claim 8, wherein a second portion of the plurality of spaced apart vibration fins of the damper extend from the second end of the body of the damper to an intermediate position on the body of the damper between the first end of the body of the damper and the second end of the body of the damper.

10. The resolver assembly of claim 9, wherein the second portion of the plurality of spaced apart vibration fins blend into an outer envelope of the body of the damper at the intermediate position.

11. The resolver assembly of claim 10, wherein the damper further comprises a tab intersecting the first end of the body of the damper and extending above the outer envelope of the body of the damper.

12. The resolver assembly of claim 11, wherein the damper further comprises a plurality of alignment pins positioned within the internal channel proximate the first end of the body of the damper.

13. A damper for a wire harness having a plurality of wires extending beyond a first end of a sheath and coupled to a header, the damper comprising:
a body having a first end and a second end and an interior channel extending from the first end to the second end, the first end sized and shaped to receive a portion of the header and the second end sized and shaped to receive a portion of the sheath, the interior channel being tapered between the first end and the second end; and
a plurality of spaced apart vibration fins extending from the body between the first end and the second end.

14. The damper of claim 13, wherein the interior channel transitions from a substantially rectilinear profile at the first end to a cylindrical profile at the second end.

15. The damper of claim 13, wherein a first portion of the plurality of spaced apart vibration fins extends from the first end of the body to the second end of the body.

16. The damper of claim 15, wherein a second portion of the plurality of spaced apart vibration fins extend from the second end of the body to an intermediate position on the body between the first end of the body and the second end of the body.

17. The damper of claim 16, wherein the second portion of the plurality of spaced apart vibration fins blend into an outer envelope of the body at the intermediate position.

18. The damper of claim 17, further comprising a tab intersecting the first end of the body and extending above the outer envelope of the body.

19. The damper of claim 13, further comprising a tab intersecting the first end of the body and extending above the outer envelope of the body.

20. The damper of claim 13, further comprising a plurality of alignment pins positioned within the internal channel proximate the first end.
